(19) United States
(12) Patent Application Publication
(10) Pub. No.: US 2025/0327674 A1
(43) Pub. Date: Oct. 23, 2025

(54) Dual Smartphone Sailing Instrument

(71) Applicant: WhitServe LLC, Stamford, CT (US)

(72) Inventor: Declan W. Whitmyer, Stamford, CT (US)

(21) Appl. No.: 19/174,063

(22) Filed: Apr. 9, 2025

Related U.S. Application Data
(60) Provisional application No. 63/635,918, filed on Apr. 18, 2024.

(51) Int. Cl. G01C 21/20; B63B 35/00; B63B 79/10; H04N 23/661

(52) U.S. Cl. CPC G01C 21/203; B63B 79/10; H04N 23/662; B63B 2035/009

(57) ABSTRACT

A pair of portable computing devices provide a camera and a display. The camera of one device may be controlled from the other device, e.g., by a button on the display of the other device or based on a signal sensed by the other device. The devices may be mounted to a sailboat to provide a sailing instrument. The devices may be mounted to the sailboat in a bracket that holds the devices in particular relation to each other, e.g., back-to-back, stacked, and/or side-by-side.

### TECHNICAL FIELD

The present disclosure relates to sailing, and, more particularly, aspects of the disclosure relate to instrumentation for a sailboat.

### BACKGROUND

Sailors are presented with many concerns while operating a sailboat. Among other things, she or he may be considering wind direction, wind speed, speed over ground, heading, angle of tack, sail shape, boom position, rudder position, distance to mark, position with respect to mark, position with respect to neighboring boats, position with respect to navigational hazards, depth under keel, communications from neighboring boats, reports from and directions to the boat crew, and instructions from the race committee.

Conventionally, sailboats carry instruments to aid the captain in understanding some of these considerations. According to Phil Gutowski's article in Sail Magazine, updated December 2023, “The fundamental sensors that make up any sailing instrument system include wind speed and direction, boatspeed, water depth and water temperature.” According to the Sail Magazine article, typical sailing instrument systems cost anywhere from $1500 to $5500 for the equipment, installation costs more. Data displays, which make the instrument systems useful to the captain, by themselves cost from $400 to $1600. The data displays may be connected to the instruments by wires or by radio frequency signals. Wireless systems are more expensive as the instruments must include transmitters.

One aspect of sailboat racing that could benefit from instrumentation—which so far has not been provided—is the jostling of boats before the start of a race. Boat captains can commit various sorts of rude or unethical behaviors (“fouls”) toward other boats, in some cases compromising safety for the sake of an advantage in crossing the start line. Although protests may be lodged with the race committee after the race, and particularly egregious fouls may even be detected by the committee in flagrante, in many cases there is not indisputable evidence whether a foul even occurred. Accordingly, a boat captain might wish to have some way of documenting their own behavior, and the behavior of captains of neighboring boats, in the time and space proximate to a race start line.

Same is true when boats come relatively close together at mark roundings. Boats are maneuvering in close quarters and claims of rule violations are common. Video might improve the sport in these moments, but the sailors are too busy making the maneuver to be controlling a video camera. Another time when video could be useful for training and/or entertaining is at times when the boat is in an anomalous situation: too heeled, too fast, too bow down, etc. Video could show if the sailors made an error or could show them correcting the anomalous situation.

### SUMMARY

The needs set forth herein as well as further and other needs and advantages are addressed by the present embodiments, which illustrate solutions and advantages described below.

According to aspects of the disclosure, a racing instrument for a sailboat includes two portable computing devices, which may be provided as smartphones, that execute complementary instances of an application program (“app”). A first of the devices executes a first instance of the app, which displays data including, for example, speed over ground of the sailboat as sensed or received by the device e.g., from the sky, or race committee (RC). A second of the devices executes a second instance of the app, which activates the camera of the second device for taking on-board video of the sailboat. Camera activation can be initiated by a signal from the first device (based on the received data or on actuation of a control at the first device), or by anomalous conditions on the sailboat, or proximity of other vessels or marks/buoys.

In some aspects of the disclosure, the two devices or smartphones are mounted to the sailboat (e.g., to the mainmast of the sailboat) such that a rear camera of the second smartphone faces toward the stern of the boat while the screen of the first smartphone also faces toward the stern of the boat. Such an arrangement enables the boat captain to view the display on the first smartphone while the second smartphone records video from the cockpit and from nearby boats (e.g., from one minute or more before the start of the race until one minute or more after the start of the race).

For example, a bracket may be provided that can be affixed to the mast; the bracket is configured to receive an edge of the first smartphone and an edge of the second smartphone such that the two smartphones are mounted together with the display of the first smartphone and the rear camera of the second smartphone being exposed toward the stern of the boat. In some instances, the two smartphones may be mounted orthogonal to each other. In other instances, the two smartphones may be mounted in a back-to-back stacked or side-by-side fashion.

In some cases, the first instance of the app on the first smartphone may be configured to cause the second instance of the app to activate the camera of the second smartphone based on a signal detected or received by the first instance of the app. Such a signal may be, for example, a time signal. For example, the race committee may broadcast the time signal from their own instance of the app. Such a signal may be a location signal, which the first smartphone may detect using its onboard GPS chip; the first instance of the app then may compare the location signal to a map or navigation chart. In other cases, the signal may be detected by the first smartphone in response to the boat captain or another user actuating a button on the first smartphone, e.g., a physical volume up or down button, or a button that the first instance of the app displays on the display of the first smartphone.

In other cases, the second instance of the app on the second smartphone may be configured to sense or determine a parameter, and to control the camera of the second smartphone based on the parameter. The parameter may be sent to the second smartphone from the first instance of the app. Alternatively, the second smartphone may sense the parameter using one or more onboard devices such as, e.g., its clock circuit, its GPS circuit, and/or its accelerometer.

In cases where the second instance of the app is responsible for activating the camera and sending the video feed, the second instance of the app may send an alert to the first instance of the app; the alert indicates that the video feed will be transmitted and causes the first instance of the app to switch to a video feed display mode.

By implementing racing instrumentation in a smartphone, which is a common electronic device, the disclosed technology may reduce the costs associated with racing sailboats. Additionally, by providing an app that can record video of a racing sailboat cockpit and surrounding boats in response to a parameter such as time-until-start or position relative to a start line, the disclosed technology may enhance the ability of boat captains and the race committee to lodge, defend, or adjudicate protests as to behavior around a race start.

Some embodiments may not have these potential advantages, and these potential advantages are not necessarily required of all embodiments. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts an arrangement of first and second smartphones, according to an aspect of the disclosure.

FIG. 2 depicts an example of a bracket for setting up the arrangement of smartphones that is shown in FIG. 1.

FIG. 3 depicts a flow chart of a method for implementing aspects of the disclosure.

FIG. 4 depicts a flow chart of a method for implementing aspects of the disclosure.

FIG. 5 depicts a schematic of selected aspects of the disclosure.

FIG. 6 depicts a schematic of selected aspects of the disclosure.

FIG. 7 depicts a schematic of selected aspects of the disclosure.

FIG. 8 depicts a schematic of selected aspects of the disclosure.

FIG. 9A and FIG. 9B depict an arrangement of smartphones, according to an aspect of the disclosure.

FIG. 10A and FIG. 10B depict an arrangement of smartphones, according to an aspect of the disclosure.

FIG. 11A and FIG. 11B depict an arrangement of smartphones, according to an aspect of the disclosure.

### DETAILED DESCRIPTION

The present teachings are described more fully hereinafter with reference to the accompanying drawings, in which the present embodiments are shown. The following description illustrates the present teachings by way of example, not by way of limitation of the principles of the present teachings.

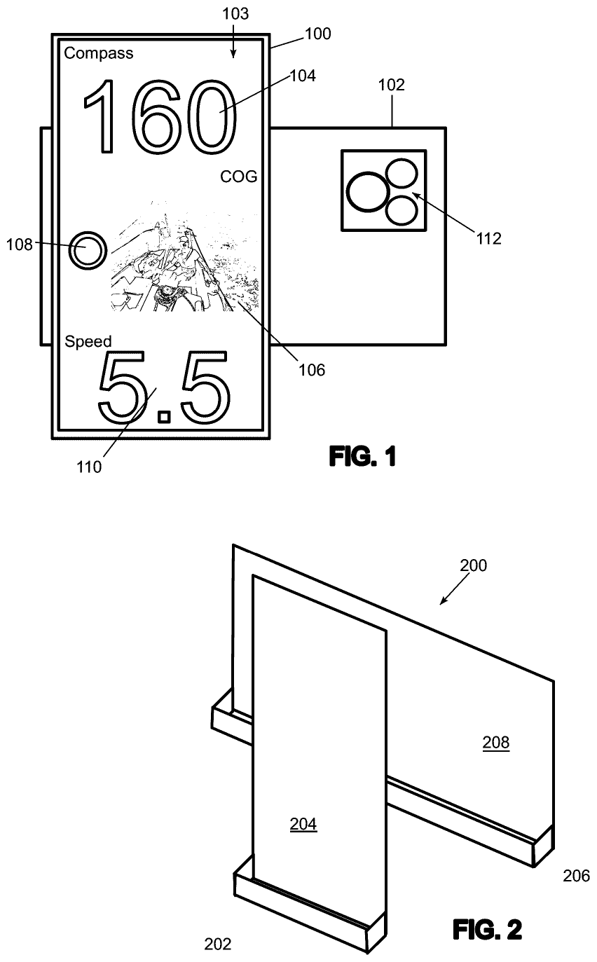

FIG. 1 depicts an arrangement of first and second smartphones 100, 102, according to an aspect of the disclosure. The first smartphone is shown running a first instance of an app on its display 103. The first instance of the app displays a compass heading or course-over-ground 104, a video feed 106 with camera start and stop button 108, and a speed-over-ground 110. The second smartphone has a plurality of cameras 112. The second smartphone is running a second instance of the app (not shown), which controls the cameras 112 and transmits the video feed 106 from the cameras 112 to the first instance of the app.

FIG. 2 depicts an example of a bracket 200 for setting up the arrangement of smartphones that is shown in FIG. 1. The bracket has a first ledge 202 and a first backing 204 for receiving the first smartphone 100 and has a second ledge 206 and a second backing 208 for receiving the second smartphone 102. The bracket 200 can be zip-tied or otherwise affixed to the mainmast or other structure of a sailboat.

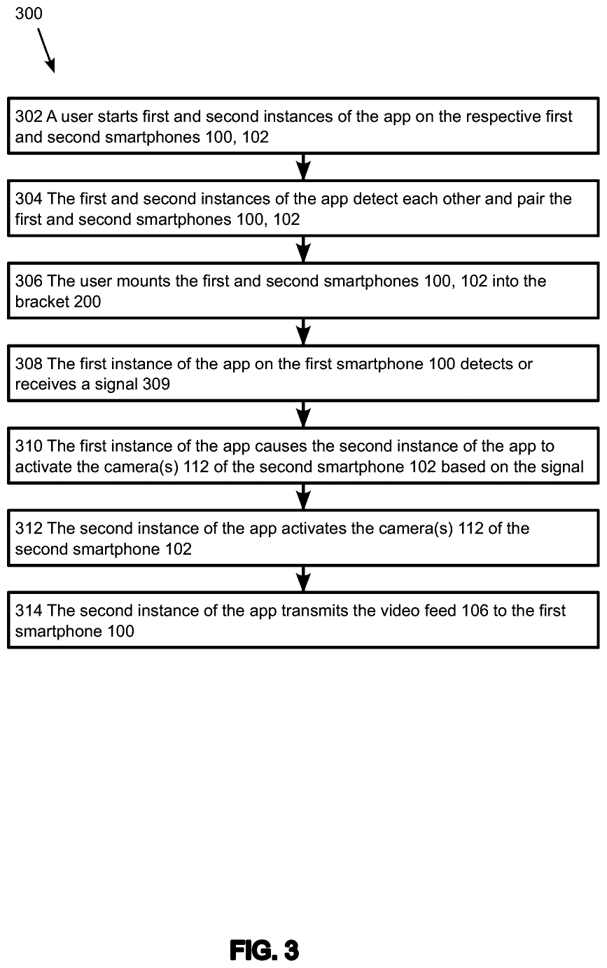

FIG. 3 depicts a flow chart of a method 300 for implementing aspects of the disclosure. Certain steps of the method 300 may be accomplished in a different order than is illustrated and described in this disclosure. At 302, a user starts first and second instances of the app on the respective first and second smartphones 100, 102. At 304, the first and second instances of the app detect each other and pair the first and second smartphones 100, 102. At 306, the user mounts the first and second smartphones 100, 102 into the bracket 200. At 308, the first instance of the app on the first smartphone 100 detects or receives a signal 309. The signal may be, for example, a time signal, a location signal, or a user actuation of the camera button 108. At 310, the first instance of the app causes the second instance of the app to activate the camera(s) 112 of the second smartphone 102 based on the signal. At 312, the second instance of the app activates the camera(s) 112 of the second smartphone 102. At 314, the second instance of the app transmits the video feed 106 to the first smartphone 100.

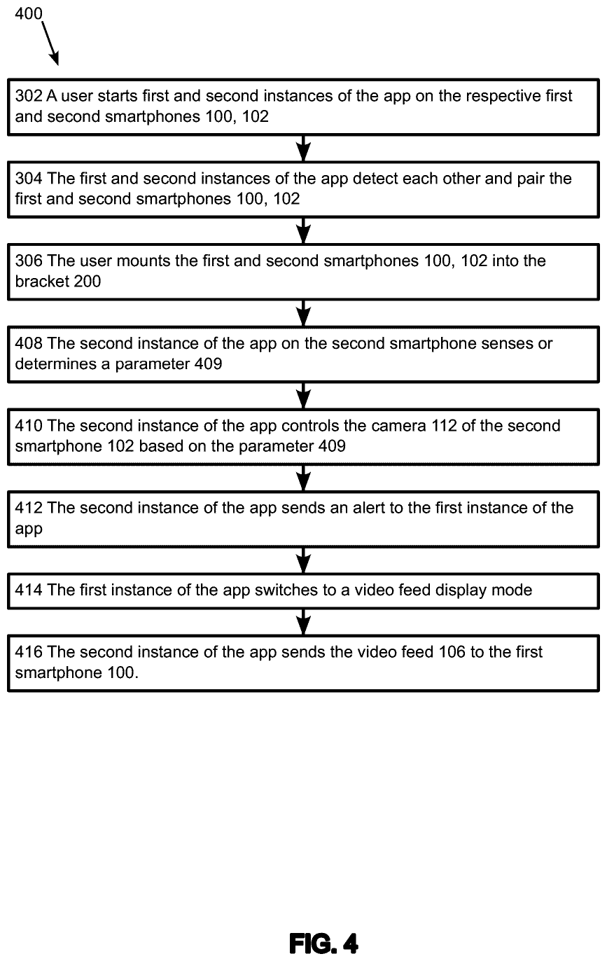

FIG. 4 depicts a flow chart of a method 400 for implementing aspects of the disclosure. Certain steps of the method 400 may be accomplished in a different order than is illustrated and described in this disclosure. At 302, a user starts first and second instances of the app on the respective first and second smartphones 100, 102. At 304, the first and second instances of the app detect each other and pair the first and second smartphones 100, 102. At 306, the user mounts the first and second smartphones 100, 102 into the bracket 200. At 408, the second instance of the app on the second smartphone senses or determines a parameter 409.

The parameter may be sent to the second smartphone from the first instance of the app. Alternatively, the second smartphone may sense the parameter using one or more onboard devices such as, e.g., its clock circuit, its GPS circuit, and/or its accelerometer. The parameter may be one or a combination of parameters selected from: a time until a sailboat race starts; proximity of the smartphone to a mark of a sailboat race, proximity of the smartphone to a second sailboat; a position of the sailboat or a position of the smartphone (e.g., a geographic position); a speed of the sailboat; a heel of the sailboat; a trim of the sailboat; a LIDAR-sensed activity on the sailboat. The app may be configured to permit a user to select one or more of the parameters for controlling the camera.

The app on the smartphone on the first sailboat may sense proximity of the second sailboat based on a wireless communication with a smartphone that executes an instance of the app aboard the second sailboat. The app may include at least one option for a user to configure the smartphone to sense one or more of the parameters. The at least one option may include a zeroing function for at least one of heel and/or trim.

The app may be a boat captain instance of the app that is configured to receive one or more of the parameters from a race committee instance of the app.

At 410, the second instance of the app controls the camera 112 of the second smartphone 102 based on the parameter 409. At 412, optionally, the second instance of the app sends an alert to the first instance of the app. At 414, the first instance of the app switches to a video feed display mode, for example as shown in FIG. 1. At 416, the second instance of the app sends the video feed 106 to the first smartphone 100.

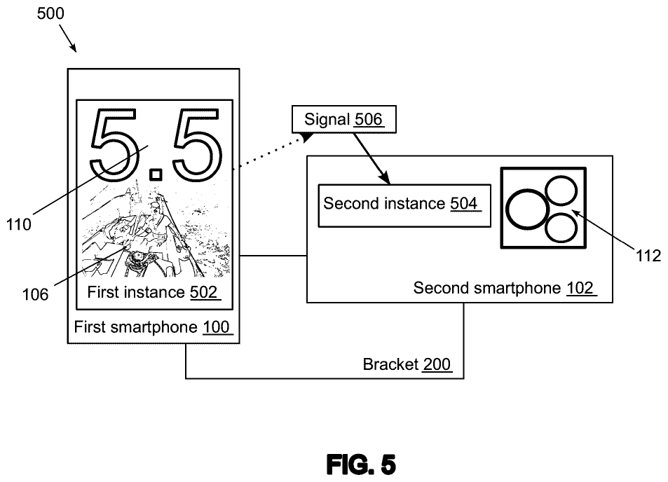

FIG. 5 depicts a schematic of a racing instrument 500 for a sailboat 502. The instrument 500 includes a first smartphone 100 and a first instance 502 of an app, which is executing on the first smartphone in a display mode for displaying at least speed over ground 110 of the sailboat as sensed by the first smartphone. The instrument 500 also includes a bracket 200 for receiving at least an edge of the first smartphone for mounting the first smartphone to the sailboat. The instrument 500 also includes a second smartphone 102 that has one or more cameras 112. The bracket 200 receives at least an edge of the second smartphone 102 for mounting the second smartphone to the first smartphone. The instrument 500 also includes a second instance 504 of the app, which is executing on the second smartphone in a camera mode for taking on-board video of the sailboat.

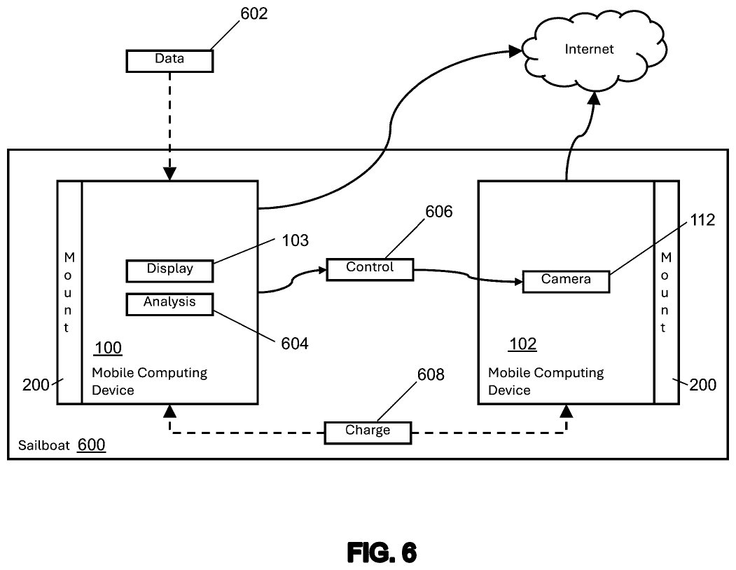

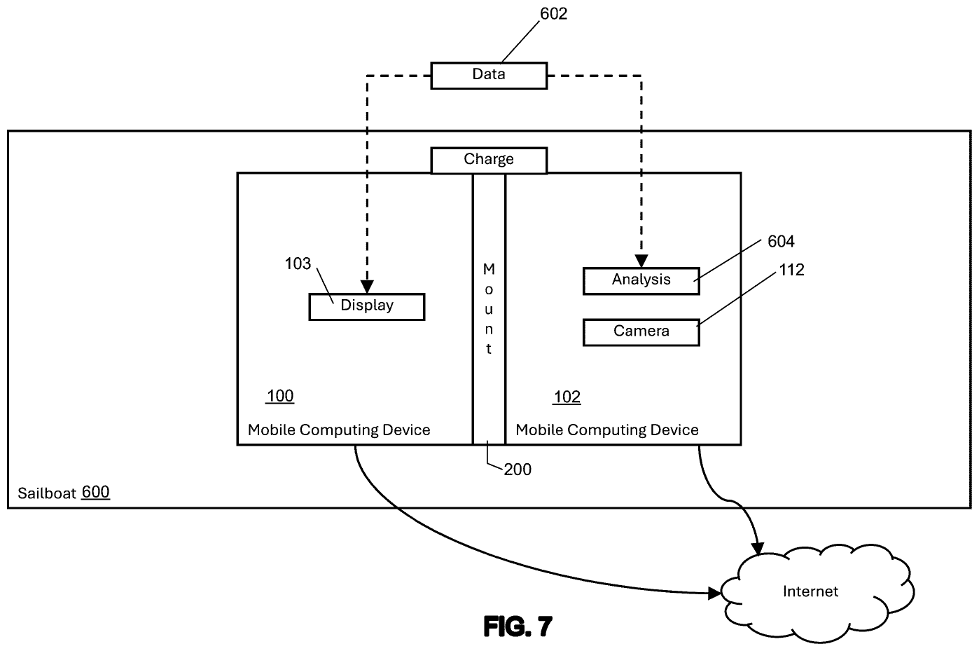

FIG. 6 depicts a schematic of selected aspects of the disclosure. According to the schematic, a first device 100 is provided on a sailboat 600 along with a second device 102. Each of the devices is affixed to the sailboat 600 by a mount or bracket 200. A single mount may be used for both devices (as shown in FIG. 7, described after), or individual mounts may be used for each device (as shown in FIG. 6). Individual mounts may be alike or different to each other.

In FIG. 6, the first device includes a display 103. The first device 100 receives data 602 and performs analysis 604 on the data 602. The first device also displays at least a portion of the data 602 via the display 103. Based on the analysis 604, the first device 100 controls 606 the second device 102, for example as discussed with reference to FIG. 1 through FIG. 5. For example, the first device controls a camera 112 of the second device. Both devices may connect to the internet. The first device and the second device may exchange charge 608 via a cable or the like, or wirelessly in case the devices are appropriately positioned with respect to each other.

FIG. 7 depicts a schematic of selected aspects of the disclosure. According to the schematic, a first device 100 is provided on a sailboat 600 along with a second device 102. Each of the devices is affixed to the sailboat 600 by a mount or bracket 200. A single mount may be used for both devices (as shown in FIG. 7), or individual mounts may be used for each device (as shown in FIG. 6, described above).

In FIG. 7, the first device 100 includes a display 103 and the second device 102 includes a camera 112. The first and second devices are connected to the Internet and receive data 602. The first device displays the data. The second device performs analysis 604 on the data and may control the camera based on the analysis. The two devices 100, 102 may receive charge via the mount 200.

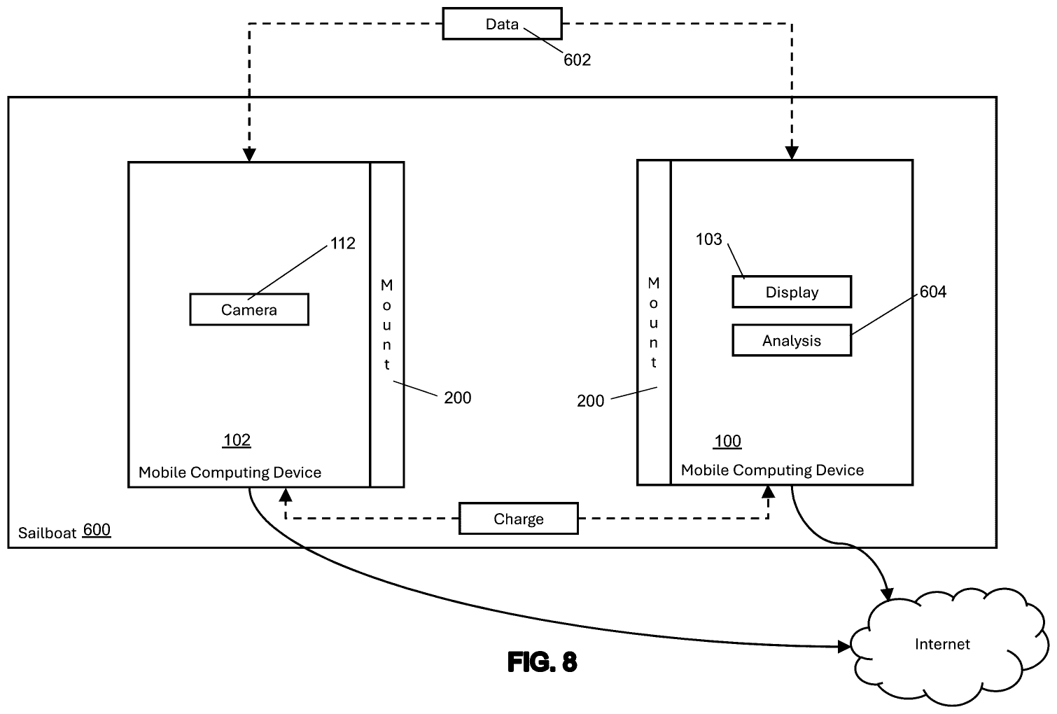

FIG. 8 depicts a schematic of selected aspects of the disclosure. Whereas in FIG. 6 a solid line indicates the instrument phone 100 “control” of the camera phone 102, in the embodiment of FIG. 8, the camera phone 102 is not controlled by the instrument phone 100 but still is able to upload footage or share data to the internet. For example, in FIG. 8 the camera 112 can be controlled by something other than the instrument phone 100. The two phones 100, 102 could share data, they could also be connected by wire for charge.

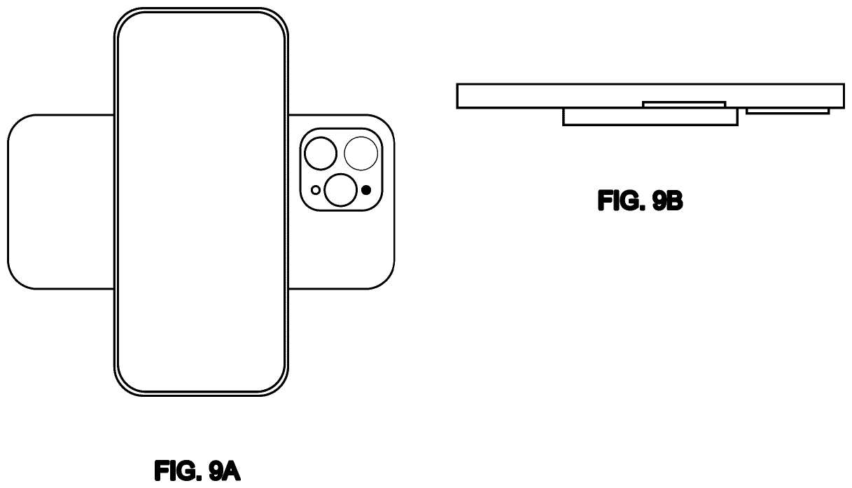

FIG. 9A and FIG. 9B depict an arrangement of smartphones, according to an aspect of the disclosure.

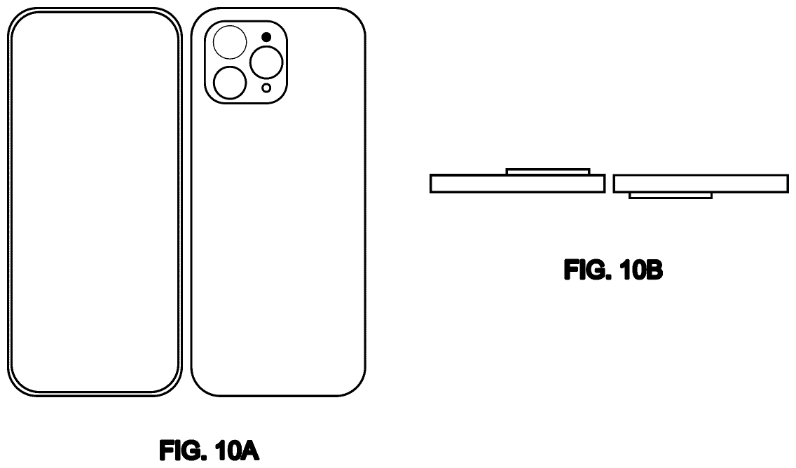

FIG. 10A and FIG. 10B depict an arrangement of smartphones, according to an aspect of the disclosure.

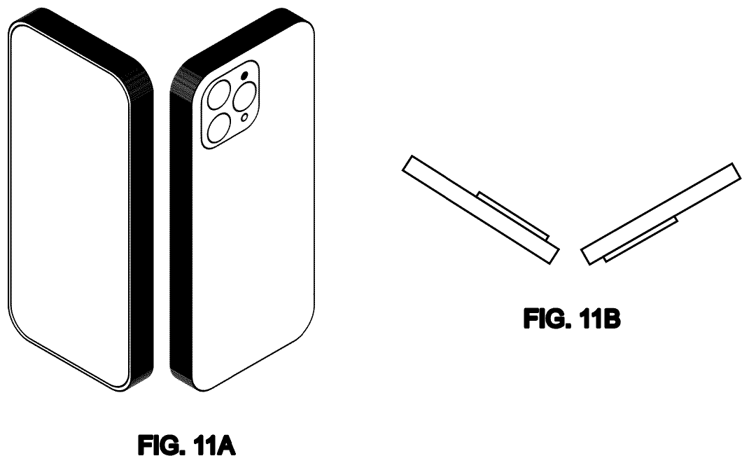

FIG. 11A and FIG. 11B depict an arrangement of smartphones, according to an aspect of the disclosure.

In some embodiments of the disclosure, the first instance 502 of the app controls the second instance 504 of the app. For example, the first instance of the app is configured to cause the second instance of the app to activate the camera(s) 112 of the second smartphone based on a signal received or detected by the first instance of the app.

In other embodiments of the disclosure, the second instance 504 of the app is configured to control the camera(s) 112 based on a signal 506 that is received or detected by the second instance of the app. Optionally, the first instance of the app sends the signal 506. On the other hand, the second instance of the app may receive or detect the signal from, e.g., a timer circuit or GPS circuit of the second smartphone.

The present teachings have been described in language more or less specific as to structural, mechanical, and functional features. It is to be understood, however, that the present teachings are not limited to the specific features shown and described, since the apparatus, system, and/or method herein disclosed comprises preferred forms of putting the present teachings into effect.

For purposes of explanation and not limitation, specific details are set forth such as particular structures, architectures, interfaces, techniques, etc. in order to provide a thorough understanding. In other instances, detailed descriptions of well-known devices and/or methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The use of “first”, “second,” etc. for different features/components of the present disclosure are only intended to distinguish the features/components from other similar features/components and not to impart any order or hierarchy to the features/components, unless explicitly stated otherwise. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification and the attached drawings.

What is claimed is:

1. An instrument for a sailboat, the instrument comprising:
a first smartphone;
a first instance of an app, executing on said first smartphone for displaying at least speed over ground of the sailboat as sensed by said first smartphone;
a bracket for receiving at least an edge of said first smartphone for mounting said first smartphone to the sailboat;
a second smartphone having one or more cameras;
said bracket for receiving at least an edge of said second smartphone for mounting said second smartphone to said first smartphone; and
a second instance of said app, executing on said second smartphone for taking on-board video of the sailboat.

2. The instrument of claim 1, wherein said first instance of said app is configured to cause said second instance of said app to activate the camera of said second smartphone based on a signal received or detected by said first instance of said app.

3. The instrument of claim 2, wherein said first instance of said app is configured to cause said second instance of said app to activate the camera of said second smartphone based on said first instance of said app receiving a time signal.

4. The instrument of claim 2, wherein said first instance of said app is configured to cause said second instance of said app to activate the camera of said second smartphone based on said first instance of said app receiving a location signal.

5. The instrument of claim 1, wherein said bracket is configured such that said second smartphone is oriented with a wide-angle camera facing towards the stern of the sailboat.

6. An instrument for a sailboat, the instrument comprising:
a first smartphone;
a first instance of an app, executing on said first smartphone for displaying at least speed over ground of the sailboat as sensed by said first smartphone;
a bracket for receiving at least an edge of said smartphone for mounting said first smartphone to the sailboat; and
a second smartphone having a camera;
said bracket for receiving at least an edge of said second smartphone for mounting said second smartphone to said first smartphone;
said second smartphone configured to sense or determine a parameter and further configured to control said camera based on said parameter.

7. The instrument of claim 6, wherein said app is configured to send said parameter to said second smartphone in response to said first smartphone receiving or detecting a signal.

8. The instrument of claim 7, wherein said first instance of said app is configured to send said parameter to said second smartphone based on said first instance of said app receiving a time signal.

9. The instrument of claim 7, wherein said first instance of said app is configured to send said parameter to said second smartphone based on said first instance of said app receiving a location signal.

10. The instrument of claim 6, wherein said parameter is a time signal.

11. The instrument of claim 6, wherein said parameter is a location signal.

12. The instrument of claim 11, wherein said second smartphone activates said camera in response to a comparison of said location signal to a map.

13. The instrument of claim 6, wherein said bracket is configured such that said second smartphone is oriented with a wide-angle camera facing towards the stern of the sailboat.

14. An instrument for a sailboat, the instrument comprising:
first and second mobile computing devices mounted to the sailboat;
an app executing on said first and second mobile computing devices for connecting said first and second mobile computing devices together for communication;
a display on said first mobile computing device;
a camera on said second mobile computing device;
a sailing data determined in said app executing on said first mobile computing device to control said camera on said second mobile computing device.

15. An instrument for a sailboat, the instrument comprising:
a first mobile computing device having a display;
a sailing data for the sailboat;
a first instance of an app, executing on said first mobile computing device for displaying said sailing data;
a second mobile computing device having a camera;
a second instance of said app, executing on said second mobile computing device for controlling the camera according to the sailing data.

16. The instrument of claim 15, wherein one of the first and second mobile computing devices charges the other mobile computing device.

17. The instrument of claim 15, further comprising a bracket for mounting said first and second mobile computing devices together on the sailboat in back-to-back configuration.

18. The instrument of claim 17, wherein the bracket includes an air gap behind one or both of the first and second mobile computing devices for cooling.

19. An instrument for a sailboat, the instrument comprising:
a smartphone that has a camera;
a bracket for receiving at least an edge of the smartphone for mounting the smartphone to the sailboat; and
an app executing on the smartphone for controlling the camera based on a sailing parameter as sensed by the smartphone.

20. The instrument of claim 19, wherein the sailing parameter is the position of the sailboat relative to a map of a sailboat race course.

21. The instrument of claim 20, wherein the app is a boat captain instance of the app that is configured to receive the map of the sailboat race course from a race committee instance of the app.

22. The instrument of claim 19, wherein the sailing parameter is a time until a start of a sailboat race, wherein the app displays the time.

23. The instrument of claim 22, wherein the app is a boat captain instance of the app and is configured to receive the time from a race committee instance of the app.

24. The instrument of claim 22, wherein the app counts the time.

25. An instrument for a sailboat, the instrument comprising:
a smartphone that has a camera;
a bracket for receiving at least an edge of the smartphone for mounting the smartphone to the sailboat; and
an app executing on the smartphone for controlling the camera based on a value of at least one parameter selected from a group consisting of: a time until a sailboat race starts; proximity of a mark of a sailboat race, proximity of a second sailboat; a position of the sailboat; a speed of the sailboat; a heel of the sailboat; a trim of the sailboat; a LIDAR-sensed activity on the sailboat; and combinations of these;
wherein the app is configured to permit a user to select one or more of the parameters for controlling the camera.

26. The instrument of claim 25, wherein the app includes at least one option for a user to configure the smartphone to sense one or more of the parameters.

27. The instrument of claim 25, wherein the app senses proximity of the second sailboat based on a wireless communication with a second smartphone that executes a second instance of the app.
